(19) United States
(12) Patent Application Publication
(10) Pub. No.: US 2020/0158649 A1
(43) Pub. Date: May 21, 2020

(54) ARRANGEMENT FOR OPTICAL EMISSION SPECTROMETRY WITH IMPROVED LIGHT YIELD

(71) Applicant: Spectro Analytical Instruments GmbH, Kleve (DE)

(72) Inventors: Dirk ARDELT, Krefeld (DE); Wolfram BOHLE, Kleve (DE)

(73) Assignees: Spectro Analytical Instruments GmbH, Kleve (DE); Spectro Analytical Instruments GmbH, Kleve (DE)

(21) Appl. No.: 16/688,034

(22) Filed: Nov. 19, 2019

(30) Foreign Application Priority Data
Nov. 19, 2018 (DE) 10 2018 129 010.1

(51) Int. Cl. G01N 21/73

(52) U.S. Cl. CPC G01N 21/73; G01N 2201/0636

(57) ABSTRACT

An arrangement for optical emission spectrometry with a spectrochemical source, which during operation emits non-directed radiation, and with a spectrometer having at least one entry aperture arranged at a side next to the source, at least one dispersive element and at least one detector, which are arranged such that during operation part of the radiation emitted in the direction of the entry aperture from the source enters the spectrometer through the entry aperture, from the entry aperture falls indirectly or directly on the dispersive element(s), is split up according to wavelengths and is registered by the at least one detector. A mirror may be arranged at a side of the source opposed to the entry aperture at a distance from the source to reflect at least one part of the radiation, not emitted in the direction of the entry aperture from the source, in the direction of the entry aperture.

The present invention relates to an arrangement with the features of the preamble of claim 1 and a method with the features of the preamble of claim 12.

A generic arrangement is known from the publication EP 2156153 A1. This publication describes an optical emission spectrometer, for example with an ICP emission source. Other spectrochemical sources, such as spark, arc or glow discharge are known and are also used for optical emission spectrometry.

The discussion takes place by way of example using the above-mentioned ICP emission source without the present invention being limited to this since the resulting advantages are also achieved for the other mentioned spectrochemical sources.

In the ICP emission source described here by way of example, a rare gas flow, usually argon, is heated by means of a high frequency excitation to plasma. The substance to be analysed is injected into the plasma. The substance is atomised due to the high temperature of the plasma and the atoms obtained in this manner from this substance are electronically excited and ionised. The radiation resulting in the case of the electronic disexcitation, which is in the wavelength range of between 100 nm and 800 nm, is split up and analysed in the spectrometer according to wavelengths. This radiation, which reaches from the vacuum UV to the near infra-red, is designated below simply as “radiation”. For the analysis, detectors are arranged in the spectrometer which in each case detect the radiation of interest of a characteristic wavelength of a chemical element and convert it into an electric signal that corresponds to the measured intensity of the emission line. A conclusion can be made from the intensities about the relative element contents in the sample.

The spectrochemical source described above by way of example, the plasma, has roughly the shape of a rotationally-symmetric “flame” with a symmetry axis oriented generally vertically, from which the generated radiation is emitted substantially undirected. The space around the plasma can theoretically be divided into two half spaces, namely a first half space, which is facing the spectrometer, and a second half space, which is facing away from the spectrometer. More specifically, the half spaces are separated by a plane which is defined by the symmetry axis of the plasma, on the one hand, and by a perpendicular on the straight line not coinciding with the symmetry axis, intersecting the middle point of the plasma, which connects the middle point of the plasma with the entry slot of the spectrometer.

The quality of a measurement for elements, which are contained only in small quantities in the sample substance, depends, amongst other things, on the signal to noise ratio. This ratio can be improved by the quality of the detectors and other parameters of the spectrometer. An essential factor in this case is, however, the absolute radiation quantity, which arrives from the emission source on the respective detector. The radiation emitted from the source in the 2nd half space is not available for the analysis in conventional arrangements for optical emission spectrometry.

It is therefore an object of the present invention to provide an arrangement, in the case of which the quantity of light available for the analysis is improved. It is also an object of the present invention to provide a method in the case of which the quantity of radiation radiated in the 2nd half space is made available at least partially for the analysis.

This object is achieved by an arrangement with the features of the preamble of claim 1 and by a method with the features of the preamble of claim 12.

Because, in the case of the generic arrangement for optical emission spectrometry, an optical element is also arranged on a side of the source opposed to the entry aperture at a distance from the source such that it leads at least one part of the radiation, which is not emitted in the direction of the entry aperture from the source, into the direction of the entry aperture, this part of the radiation can enter into the spectrometer and is then available as an additional signal for improving the signal to noise ratio.

In a particularly preferred embodiment, the optical element may be a mirror. In this case, the term “mirror” should be understood as being one or a plurality of elements which are suitable for reflecting electromagnetic radiation of the wavelength range mentioned in the introduction. Mirrors with a surface reflection are preferred.

When a transfer optic is arranged between the source and the entry slot, the radiation yield can be improved further.

The mirror is preferably a spherical mirror since such a mirror is easy and economical to produce. This is particularly advantageous when the mirror is supposed to be replaced regularly during the service life.

It is in particular advantageous when the mirror has a curvature radius which corresponds to 0.8 times to 1.4 times the distance of the mirror from the source. Selected regions of the source, which do not coincide with the symmetry axis, can then be imaged on the inlet aperture. It can also be provided that the mirror images the source on itself. This has been proven to be particularly advantageous in particular in the case of inconsistency of the orientation of the main symmetry axes of the source and entry aperture of the emission spectrometer since, in this case, all beam directions in the acceptance bundle of the spectrometer can be reused and a double light quantity, compared to the embodiment above without the suitably arranged spherical mirror, is transported into the spectrometer.

For the analysis of different regions of the source, it may be advantageous when the mirror is moveable, rotatable and/or tiltable before or during the measurement.

The portion of the radiation reflected back from the second half space can be varied when an aperture with variable opening is provided in particular between the source and the mirror, wherein the variable opening is also fully closable in a preferred embodiment.

When, in a preferred embodiment, a window and/or an optical filter are provided between the source and the mirror, the radiation incident on the mirror can be filtered. Thus, for example in the case of particularly intense UV sources, the UV radiation can be reduced or completely blocked such that UV-induced photolysis or radiation damage to the mirror surface can be reduced or avoided. The service life of the mirror is increased in the case of such applications, as a result.

Because, in the case of a generic method for optical emission spectrometry, it is also provided that the radiation of the spectrochemical source emitted in the second half space facing away from the spectrometer leads into the spectrometer at least partially through a suitable optical element, additional radiation is available in the spectrometer and the method can be carried out with an improved signal to noise ratio.

The optical element is preferably a mirror, in particular a mirror which images the source on itself.

In the case of the method, different regions of the source can be analysed when the mirror is moved, tilted or rotated before or during the measurement. The properties of the spectrometer or the adjustment to a particular measurement environment can be improved when a transfer optic is used to adjust the source emission to parameters of the spectrometer.

Lastly, it may be advantages e.g. for the service life of the mirror when the radiation emitted in the second half space is filtered before impinging on the mirror. Silica or CaF₂-windows are for example advantageous to protect against UV damage.

In other exemplary embodiments, the use of a flat or an aspherical mirror is provided in order to achieve the described improvement, just like the use of another or further optical elements, for example lenses, fixed or variable aperture screens, optical filters or light path closures, in combination with the previously described mirrors or also separately therefrom. In this case, additional advantageous properties of the described arrangement can be implemented in particular in the case of a combination of a plurality of optical elements.

A favourable arrangement results for example when, for a spectrochemical source of spherical or cylinder-symmetrical symmetry, a spherical mirror of suitable focal length is arranged at such a distance from the entry slot such that a focussed imaging of the electromagnetic radiation emitted from the spectrochemical source into the half space facing away from the spectrometer reaches the entry slot. In this case, there is also a correct adjustment of the source to the spectrometer for this portion of the emitted source radiation.

Further favourable arrangements are conceivable and combine a plurality of optical elements, for example one or a plurality of additional lenses or filters in the radiation path in order to adjust imaging properties or to screen out unwanted or disturbing radiation of certain wavelengths.

An exemplary embodiment of the invention is described in greater detail below using the drawing, wherein:

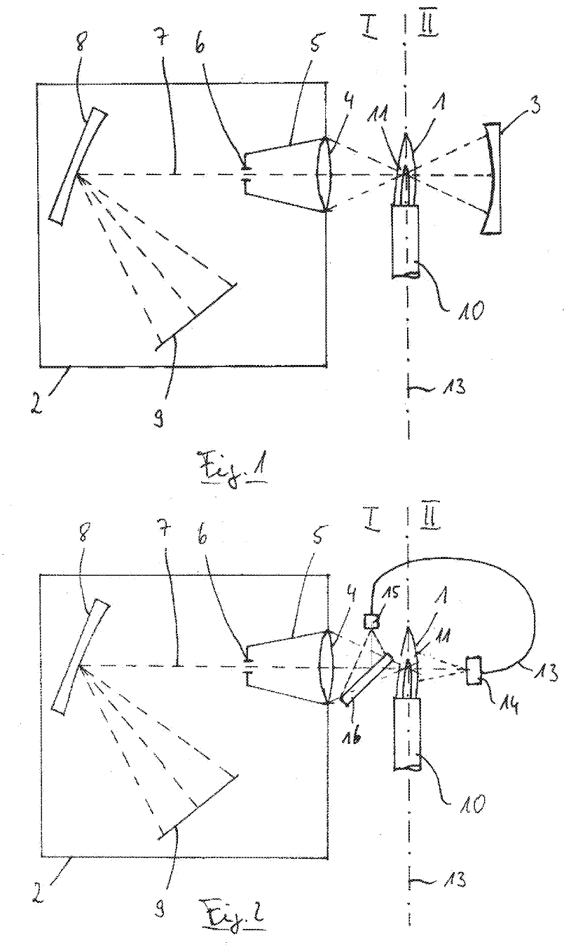

FIG. 1: shows an arrangement according to the invention with a mirror in a schematic representation; and

FIG. 2: shows a correspondingly structured arrangement with a light guide.

FIG. 1 shows an arrangement with a spectrochemical source 1, a spectrometer 2 and a mirror 3. The spectrometer 2 has a spectrometer housing and a transfer optic consisting of a lens 4 and a lens barrel 5. The lens barrel 5 bears an entry slot 6. An optical axis 7 runs from the centre of the source 1 through the lens 4 and the entry slot 6 to a dispersive element 8 in the form of a grid. Moreover, a detector 9 is arranged in the spectrometer 2, which can receive radiation from the grid 8 and convert it into electric signals.

The source 1 is represented only schematically and comprises a tube 10 from which an argon flow exits upwards. A coil not represented generates, in a known manner, a high-frequency field in the region of the argon flow. The argon couples to the field such that a plasma 11 is generated. In the plasma, sample material is then atomised, ionised and excited for radiation.

The source 1 is substantially rotationally-symmetric to a symmetry axis 13 oriented vertical in this exemplary embodiment. The radiation generated there is radiated to the same parts in a first half space I, which spans left from the symmetry axis 13 in the representation of FIG. 1, and in a second half space II, which is right of the symmetry axis 13 in FIG. 1. The radiation emitted to the left in the first half space I is focussed partly (corresponding to the geometric arrangement) by the lens 4 on the entry gap 6 and arrives from there on the grid 8. The grid 8 then splits up the incident polychromatic radiation depending on the wavelength and guides the resulting spectrum to the detector 9, which can be formed here as a CCD or CMOS array.

The mirror 3 is arranged in the second half space II, which is configured here as a spherical hollow mirror. The mirror 3 is arranged such that a part of the radiation emitted from the source 1 into the second half space II is imaged back on the source 1 and also impinges on the lens 4 through the substantially transparent source 1. From there, the part of the radiation reflected by the mirror 3 also arrives into the spectrometer 2 and is processed there precisely as the part of the radiation emitted directly from the source 1 into the left half space I, which was described further above.

Through this arrangement, a part of the radiation emission is thus utilised during operation which is radiated into the second half space II and which would be lost for the analysis without the mirror 3.

Proceeding from the fundamental configuration of FIG. 1, which represents a general exemplary embodiment, the mirror 3 can for example be moved in any direction desired for further analysis methods such that another part of the source 1 can be imaged and reflected to the spectrometer 2. As a result, other regions of the source 1 are accessible for the evaluation in which other atomic physical processes that are of interest for the analysis take place. The represented arrangement of the mirror 3 also allows the radiation, which falls on the mirror 3 from the source 1, to be influenced since for example filters or apparatuses can be arranged in this region, for which insufficient space is available in the left half space I between the source 1 and the lens 4.

Another embodiment is illustrated in FIG. 2. Identical constructive elements and drawing elements bear the same reference numerals.

In the case of this exemplary embodiment, the entry end of a light guide is arranged in the second half space II with corresponding optics 14 to couple the light into the light guide 13. The light guided into the light guide is then guided to a second optic 15 where it is coupled out and arrives at a semi-transparent or dichroitic mirror 16. The mirror 16 reflects the light coming from the light guide 13 in the direction of the lens 4. There, like the light coming directly from the source 1, it is guided into the spectrometer 2 for measurement.

The optic 14 can be placed largely as desired such that light from different regions of the plasma 11 can be analysed. In one application, e.g. the optic 14 can be placed in the axis 13 above the plasma 11 and the emission in the axial direction of the source 1 can thus be detected. If this alignment of the optic 14 is selected, axial and radial radiation of the source 1 can be simultaneously measured, since both emission components can be led into the same spectrometer optic.

1. An arrangement for optical emission spectrometry, the arrangement including:
a spectrochemical source, which during operation emits non-directed radiation,
a spectrometer which has at least one entry aperture arranged at a side next to the source,
at least one dispersive element,
at least one detector, wherein the source, the spectrometer, the at least one entry aperture, the at least one dispersive element, and the at least one detector are arranged such that during operation a part of the radiation emitted from the source in a direction of the entry aperture enters the spectrometer through the entry aperture, from the entry aperture falls indirectly or directly on the at least one dispersive element, is split up according to wavelengths, and is registered by the at least one detector, and
at least one optical element arranged at a side of the source opposed to the entry aperture at a distance from the source such that at least one part of the radiation not emitted from the source in the direction of the entry aperture is directed by the at least one optical element toward the entry aperture.

2. The arrangement according to claim 1, further including a transfer optic arranged between the source and the entry aperture.

3. The arrangement according to claim 1, wherein the optical element is a mirror, which is arranged such that the mirror reflects at least one part of the radiation, not emitted in the direction of the entry aperture from the source, into the direction of the entry aperture.

4. The arrangement according to claim 3, wherein the mirror is a spherical mirror.

5. The arrangement according to claim 3, wherein the mirror has a curvature radius which corresponds to 0.8 times to 1.4 times a distance of the mirror from the source.

6. The arrangement according to claim 2, wherein the mirror images the source on itself.

7. The arrangement according to claim 2, preceding claims, wherein the mirror is movable, rotatable and/or tiltable.

8. The arrangement according to claim 1, wherein the optical element is a light guide.

9. The arrangement according to claim 1, further including characterised in that an aperture with variable opening is provided.

10. The arrangement according to claim 8, wherein the aperture with variable opening is arranged between the source and the mirror or the light guide.

11. The arrangement according to claim 1, wherein a window and/or an optical filter is/are provided between the source and the mirror or the light guide.

12. A method for optical emission spectrometry, the method including:
generating an emission spectrum of a spectrochemical source; and
measuring and evaluating the emission spectrum using data processing, wherein the generating and measuring and evaluating utilize an arrangement with a spectrochemical source, in which electromagnetic radiation characteristic of a sample to be examined is generated and emitted in a half space facing at least one entry slot and a half space facing away from the entry slot, the arrangement further having a spectrometer comprising the at least one entry slot, at least one dispersive element, one or more exit slots, and detectors for detecting the dispersed radiation, wherein the radiation of the spectrochemical source emitted into the half space facing away from the spectrometer is led at least partially through a suitable optical element into the spectrometer.

13. The method according to claim 12, wherein the optical element is a mirror.

14. The method according to claim 13, wherein the mirror images the source on itself.

15. The method according to claim 13, further comprising moving, tilting and/or rotating characterised in that the mirror is moved, tilted or rotated before or during the measurement.

16. The method according to claim 12, wherein the optical element is a light guide.

17. The method according to claim 16, further comprising filtering characterised in that the radiation emitted in the second half space before the radiation emitted in the second half space impinges on the light guide.

18. The method according to claim 12, further comprising using a transfer optic is used to adjust the source emission to parameters of the spectrometer.

19. The method according to claim 12, wherein the one or more exit slots are integrated into the detectors.

20. The method according to claim 13, further comprising filtering the radiation emitted in the second half space before the radiation emitted in the second half space impinges on the mirror.
